(19) United States
(12) Patent Application Publication
(10) Pub. No.: US 2004/0064737 A1
(43) Pub. Date: Apr. 1, 2004

(54) Hash-based systems and methods for detecting and preventing transmission of polymorphic network worms and viruses

(76) Inventors: Walter Clark Milliken, Dover, NH (US); William Timothy Strayer, West Newton, MA (US)

Correspondence Address: Leonard Charles Suchyta, c/o Charistian Andersen, Verizon Corporate Services Group Inc., 600 Hidden Ridge, HQE03H01, Irving, TX, 75038, US

(21) Appl. No.: 10/655,245

(22) Filed: Sep. 4, 2003

Related U.S. Application Data
(63) Continuation-in-part of application No. 10/251,403, filed on Sep. 20, 2002.
(63) Continuation-in-part of application No. 09/881,145, filed on Jun. 14, 2001.
Application No. 09/881,145 is a continuation-in-part of application No. 09/881,074, filed on Jun. 14, 2001.
(60) Provisional application No. 60/407,975, filed on Sep. 5, 2002.
(60) Provisional application No. 60/341,462, filed on Dec. 14, 2001.
(60) Provisional application No. 60/212,425, filed on Jun. 19, 2000.

(51) Int. Cl. G06F 11/30

(52) U.S. Cl. 713/201

(57) ABSTRACT

A system (200) detects transmission of potentially malicious packets. The system (200) receives, or otherwise observes, packets and generates hash values based on variable-sized blocks of the packets. The system (200) then compares the generated hash values to hash values associated with prior packets. The system (200) determines that one of the received packets is a potentially malicious packet when one or more of the generated hash values associated with the received packet match one or more of the hash values associated with the prior packets.

### DESCRIPTION OF RELATED ART

Availability of low cost computers, high speed networking products, and readily available network connections has helped fuel the proliferation of the Internet. This proliferation has caused the Internet to become an essential tool for both the business community and private individuals. Dependence on the Internet arises, in part, because the Internet makes it possible for multitudes of users to access vast amounts of information and perform remote transactions expeditiously and efficiently. Along with the rapid growth of the Internet have come problems caused by malicious individuals or pranksters launching attacks from within the network. As the size of the Internet continues to grow, so does the threat posed by these individuals.

The ever-increasing number of computers, routers, and connections making up the Internet increases the number of vulnerable points from which these malicious individuals can launch attacks. These attacks can be focused on the Internet as a whole or on specific devices, such as hosts or computers, connected to the network. In fact, each router, switch, or computer connected to the Internet may be a potential entry point from which a malicious individual can launch an attack while remaining largely undetected. Attacks carried out on the Internet often consist of malicious packets being injected into the network. Malicious packets can be injected directly into the network by a computer, or a device attached to the network, such as a router or switch, can be compromised and configured to place malicious packets onto the network.

One particularly troublesome type of attack is a self-replicating network-transferred computer program, such as a virus or worm, that is designed to annoy network users, deny network service by overloading the network, or damage target computers (e.g., by deleting files). A virus is a program that infects a computer or device by attaching itself to another program and propagating itself when that program is executed, possibly destroying files or wiping out memory devices. A worm, on the other hand, is a program that can make copies of itself and spread itself through connected systems, using up resources in affected computers or causing other damage.

Various defenses, such as e-mail filters, anti-virus programs, and firewall mechanisms, have been employed against viruses and worms. Unfortunately, many viruses and worms are polymorphic. Polymorphic viruses and worms include viruses and worms that deliberately have a different set of bytes in each copy, as opposed to being substantially similar in each copy, to make them difficult to detect. Detection techniques based on byte sequence comparison, including older virus-detection techniques, may be generally ineffective in detecting polymorphic viruses and worms.

Accordingly, there is a need for new defenses to thwart the attack of polymorphic viruses and worms.

### SUMMARY OF THE INVENTION

Systems and methods consistent with the present invention address these and other needs by providing a new defense that attacks malicious packets, such as polymorphic viruses and worms, at their most common denominator (i.e., the need to transfer a copy of their code over a network to multiple target systems).

In accordance with an aspect of the invention as embodied and broadly described herein, a method for detecting transmission of potentially malicious packets is provided. The method includes receiving packets; generating hash values based on variable-sized blocks of the received packets; comparing the generated hash values to hash values associated with prior packets; and determining that one of the received packets is a potentially malicious packet when one or more of the generated hash values associated with the received packet match one or more of the hash values associated with the prior packets.

In accordance with another aspect of the invention, a system for hampering transmission of potentially malicious packets is provided. The system includes means for observing packets, means for generating hash values based on variable-sized blocks of the observed packets, and means for comparing the generated hash values to hash values corresponding to prior packets. The system further includes means for identifying one of the observed packets as a potentially malicious packet when the generated hash values corresponding to the observed packet match the hash values corresponding to the prior packets, and means for hampering transmission of the observed packet when the observed packet is identified as a potentially malicious packet.

In accordance with yet another aspect of the invention, a device for detecting transmission of malicious packets is provided. The device includes a hash memory and a hash processor. The hash memory is configured to store information associated with hash values corresponding to prior packets. The hash processor is configured to observe a packet and generate one or more hash values based on variable-sized blocks of the packet. The hash processor is further configured to compare the one or more generated hash values to the hash values corresponding to the prior packets and identify the packet as a potentially malicious packet when a predetermined number of the one or more generated hash values match the hash values corresponding to the prior packets.

In accordance with a further aspect of the invention, a method for detecting transmission of a potentially malicious packet is provided. The method includes receiving a packet, selecting blocks of the received packet of random block sizes, and performing multiple different hash functions on each of the blocks to generate multiple hash values. The method further includes comparing the generated hash values to hash values associated with prior packets, and identifying the received packet as a potentially malicious packet when one or more of the generated hash values correspond to one or more of the hash values associated with the prior packets.

In accordance with another aspect of the invention, a method for detecting transmission of a potentially malicious packet is provided. The method includes receiving a packet, selecting multiple blocks of the received packet of different block sizes, and performing a different hash function on each of the blocks to generate multiple hash values. The method further includes comparing the generated hash values to hash values associated with prior packets, and identifying the received packet as a potentially malicious packet when one or more of the generated hash values correspond to one or more of the hash values associated with the prior packets.

In accordance with yet another aspect of the invention, a method for detecting files suspected of containing a virus or worm on a computer is provided. The method includes receiving one or more first hash values associated with the virus or worm, hashing one or more variable-sized portions of the files to generate second hash values, comparing the second hash values to the one or more first hash values, and identifying one of the files as a file suspected of containing the virus or worm when one or more of the second hash values correspond to at least one of the one or more first hash values.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of a system in which systems and methods consistent with the present invention may be implemented;

FIG. 2 is an exemplary diagram of packet detection logic according to an implementation consistent with the principles of the invention;

FIGS. 3A-3C illustrate three possible data structures that may be used within the hash memory of FIG. 2 in implementations consistent with the principles of the invention; and

FIG. 4 is a flowchart of exemplary processing for detecting and/or preventing transmission of a malicious packet, such as a polymorphic virus or worm, according to an implementation consistent with the principles of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide mechanisms to detect and/or prevent the transmission of malicious packets. Malicious packets, as used herein, may include polymorphic viruses and worms, but may also apply to non-polymorphic viruses and worms and possibly other types of data with duplicated content, such as illegal mass e-mail (e.g., spam), that are repeatedly transmitted through a network.

Polymorphic viruses and worms are generally composed of two pieces: an obscured payload (which contains the majority of the virus/worm), and a decoding bootstrap that must be initially executable by the victim machine “as is,” and turns the obscured payload into the executable remainder of the virus/worm. The design of the polymorphic viruses and worms are such that the contents of the obscured payload are essentially undetectable (e.g., by strong encryption), leaving two basic ways to detect the virus/worm: (1) detect it after the decoding bootstrap has run, which is a technique employed by many of today's virus detection software; and (2) detect the decoding bootstrap in a manner consistent with the principles of the invention.

While the decoding bootstrap must be executable by the target machine, it does not have to be the exact same code for every copy of the virus/worm. In other words, it can be made arbitrarily variable, as long as the effect of executing it results in the decoding of the obscured payload.

The most sophisticated polymorphic viruses/worms employ techniques, such as the interspersal of “no-ops” or other code that does not affect the decoding process, but adds to the variability of the byte string making up the decoder bootstrap. Another technique includes changing details of instructions in the actual decoder code, such as changing which registers are employed by the decoding code, or stringing small code fragments together with “branch” or “jump” instructions, allowing the execution sequence of the instructions to be relatively independent of the sequence of bytes making up the decoder bootstrap. “Dead” code, or gibberish bytes, can also be inserted between active code segments strung together this way.

Thus, detecting the decoder bootstrap of a polymorphic virus/worm is a very difficult task. It is most difficult when only one copy of the virus/worm is examined. When many potential copies of the virus/worm can be observed, however, certain similarities between various copies will eventually emerge, because there are only a finite set of transformations that the decoding bootstrap can be put through and still function properly. This opens up the opportunity to detect such viruses/worms in places where many copies can be observed over time, such as in the network nodes (and links) through which they propagate.

Another vulnerability to detection that some e-mail-based viruses/worms have is that they require user interaction with the message carrying the virus/worm in order to be executed. Thus, they are often accompanied by a text message in the body of the e-mail that is designed to entice the user into performing the necessary action to execute the virus/worm (usually opening a file attached to the e-mail message). A polymorphic virus/worm could relatively easily change the e-mail text used in minor ways, but to make substantial changes would likely render the message incoherent to the receiver and, thus, either make him suspicious or unlikely to perform the action needed for the virus/worm to execute. Systems and methods consistent with the principles of the invention can also detect the text of the e-mail message as possibly related to a virus/worm attack.

Systems and methods consistent with the principles of the invention hash incoming packets, using a varying hash-block size, varying between a minimum and a maximum value. The hash block size may be chosen randomly within this interval for each block, but other methods of varying the block size could also be used, as long as the method was not easily predictable by an attacker.

This serves two purposes. First, it reduces the need to hash multiple copies of non-polymorphic viruses/worms for pretraining, because each packet would now have a finite chance of sharing a block with previous packets, rather than no chance, if it did not share a prior copy's alignment within a packet. Second, it allows relatively short sequences of bytes to be hashed sometimes, greatly improving the chances of catching a fixed segment of a polymorphic virus/worm.

Exemplary System Configuration

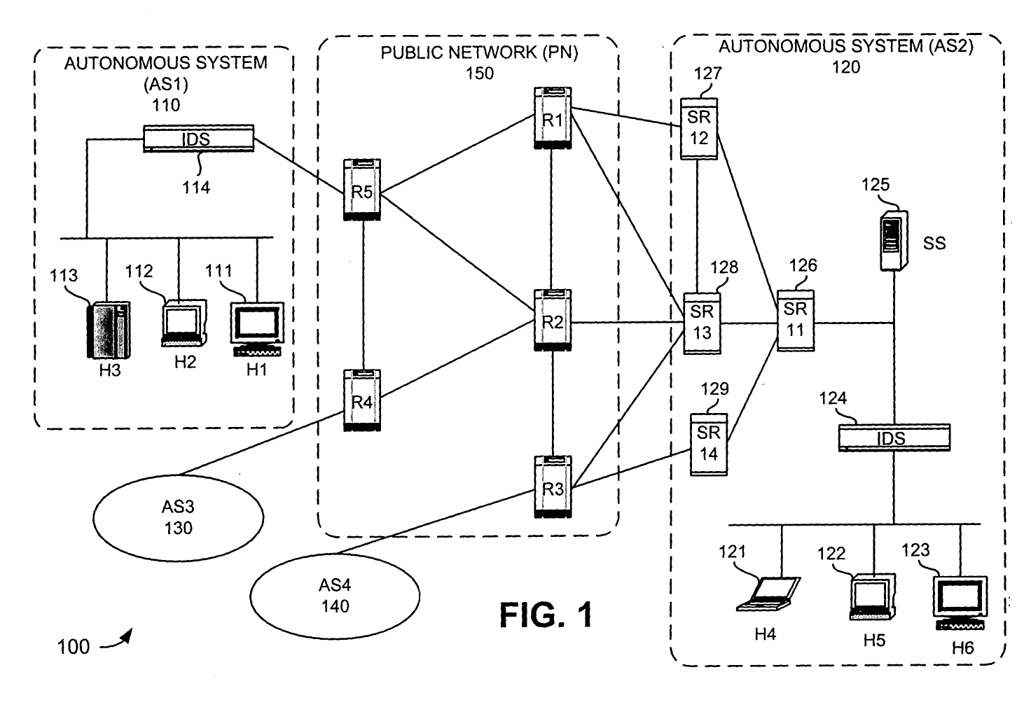

FIG. 1 is a diagram of an exemplary system 100 in which systems and methods consistent with the present invention may be implemented. System 100 includes autonomous systems (ASs) 110-140 connected to public network (PN) 150. Connections made in system 100 may be via wired, wireless, and/or optical communication paths. While FIG. 1 shows four autonomous systems connected to a single public network, there can be more or fewer systems and networks in other implementations consistent with the principles of the invention.

Public network 150 may include a collection of network devices, such as routers (R1-R5) or switches, that transfer data between autonomous systems, such as autonomous systems 110-140. In an implementation consistent with the present invention, public network 150 takes the form of the Internet, an intranet, a public telephone network, a wide area network (WAN), or the like.

An autonomous system is a network domain in which all network devices (e.g., routers) in the domain can exchange routing tables. Often, an autonomous system can take the form of a local area network (LAN), a WAN, a metropolitan area network (MAN), etc. An autonomous system may include computers or other types of communication devices (referred to as “hosts”) that connect to public network 150 via an intruder detection system (IDS), a firewall, one or more border routers, or a combination of these devices.

Autonomous system 110, for example, includes hosts (H) 111-113 connected in a LAN configuration. Hosts 111-113 connect to public network 150 via an intruder detection system (IDS) 114. Intruder detection system 114 may include a commercially-available device that uses rule-based algorithms to determine if a given pattern of network traffic is abnormal. The general premise used by an intruder detection system is that malicious network traffic will have a different pattern from normal, or legitimate, network traffic.

Using a rule set, intruder detection system 114 monitors inbound traffic to autonomous system 110. When a suspicious pattern or event is detected, intruder detection system 114 may take remedial action, or it can instruct a border router or firewall to modify operation to address the malicious traffic pattern. For example, remedial actions may include disabling the link carrying the malicious traffic, discarding packets coming from a particular source address, or discarding packets addressed to a particular destination.

Autonomous system 120 contains different devices from autonomous system 110. These devices aid autonomous system 120 in identifying and/or preventing the transmission of potentially malicious packets within autonomous system 120 and tracing the propagation of the potentially malicious packets through autonomous system 120 and, possibly, public network 150. While FIG. 1 shows only autonomous system 120 as containing these devices, other autonomous systems, including autonomous system 110, may include them.

Autonomous system 120 includes hosts (H) 121-123, intruder detection system (IDS) 124, and security server (SS) 125 connected to public network 150 via a collection of devices, such as security routers (SR11-SR14) 126-129. Hosts 121-123 may include computers or other types of communication devices connected, for example, in a LAN configuration. Intruder detection system 124 may be configured similar to intruder detection system 114.

Security server 125 may include a device, such as a general-purpose computer or a server, that performs source path identification when a malicious packet is detected by intruder detection system 124 or a security router 126-129. While security server 125 and intruder detection system 124 are shown as separate devices in FIG. 1, they can be combined into a single unit performing both intrusion detection and source path identification in other implementations consistent with the present invention.

Security routers 126-129 may include network devices, such as routers, that may detect and/or prevent the transmission of malicious packets and perform source path identification functions. Security routers 127-129 may include border routers for autonomous system 120 because these routers include connections to public network 150. As a result, security routers 127-129 may include routing tables for routers outside autonomous system 120.

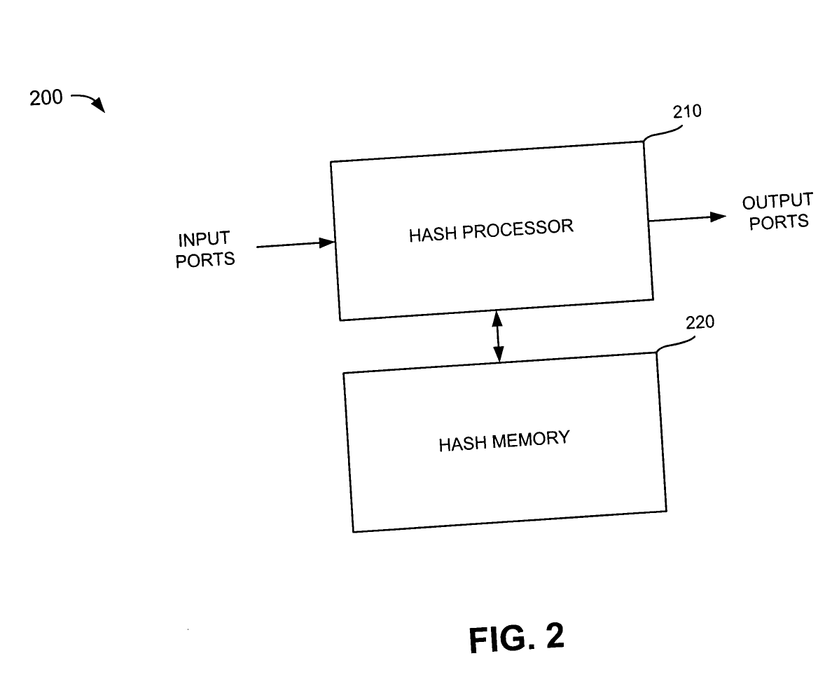

FIG. 2 is an exemplary functional block diagram of packet detection logic 200 according to an implementation consistent with the principles of the invention. Packet detection logic 200 may be implemented within a device that taps one or more bidirectional links of a router, such as security routers 126-129, an intruder detection system, such as intruder detection systems 114 and 124, a security server, such as security server 125, a host, such as hosts 111-113 and 121-123, or another type of device. In another implementation, packet detection logic 200 may be implemented within one of these devices. In the discussion that follows, it may be assumed that packet detection logic 200 is implemented within a security router.

Packet detection logic 200 may include hash processor 210 and hash memory 220. Hash processor 210 may include a conventional processor, an application specific integrated circuit (ASIC), a field-programmable gate array (FPGA), or some other type of device that generates one or more representations for each received packet and records the packet representations in hash memory 220.

A packet representation will likely not be a copy of the entire packet, but rather it may include a portion of the packet or some unique value representative of the packet. Because modern routers can pass gigabits of data per second, storing complete packets is not practical because memories would have to be prohibitively large. By contrast, storing a value representative of the contents of a packet uses memory in a much more efficient manner. By way of example, if incoming packets range in size from 256 bits to 1000 bits, a fixed width number may be computed across blocks making up the content (or payload) of a packet in a manner that allows the entire packet to be identified.

To further illustrate the use of representations, a 32-bit hash value, or digest, may be computed across blocks of each packet. Then, the hash value may be stored in hash memory 220 or may be used as an index, or address, into hash memory 220. Using the hash value, or an index derived therefrom, results in efficient use of hash memory 220 while still allowing the content of each packet passing through packet detection logic 200 to be identified.

Systems and methods consistent with the present invention may use any storage scheme that records information about each packet in a space-efficient fashion, that can definitively determine if a packet has not been observed, and that can respond positively (i.e., in a predictable way) when a packet has been observed. Although systems and methods consistent with the present invention can use virtually any technique for deriving representations of packets, the remaining discussion will use hash values as exemplary representations of packets having passed through a participating router.

Hash processor 210 may determine one or more hash values over variable-sized blocks of bytes in the payload field (i.e., the contents) of an observed packet. When multiple hashes are employed, they may, but need not, be done on the same block of payload bytes. As described in more detail below, hash processor 210 may use the hash results of the hash operation to recognize duplicate occurrences of packet content and raise a warning if it detects packets with replicated content within a short period of time. Hash processor 210 may also use the hash results for tracing the path of a malicious packet through the network.

According to implementations consistent with the present invention, the content (or payload) of a packet may be hashed to detect the packet or trace the packet through a network. In other implementations, the header of a packet may be hashed. In yet other implementations, some combination of the content and the header of a packet may be hashed.

In one implementation consistent with the principles of the invention, hash processor 210 may perform three hashes covering each byte of the payload field. Thus, a hash block size may be chosen uniformly from a range of 4 to 128 bytes, in 4-byte increments (to accommodate a common data-path granularity in high-speed network devices). At the start of the packet payload, hash processor 210 may select a random block size from this range and hash the block with the three different hash functions, or hash processor 210 may select a different block size for each hash function. In the former case, a new block size may be chosen when the first block finishes, and all three hash functions may start at the same place on the new block. In the latter case, as each hash function completes its current block, it selects a random size for the next block it will hash.

Each hash value may be determined by taking an input block of data and processing it to obtain a numerical value that represents the given input data. Suitable hash functions are readily known in the art and will not be discussed in detail herein. Examples of hash functions include the Cyclic Redundancy Check (CRC) and Message Digest 5 (MD5). The resulting hash value, also referred to as a message digest or hash digest, may include a fixed length value. The hash value may serve as a signature for the data over which it was computed. For example, incoming packets could have fixed hash value(s) computed over their content.

The hash value essentially acts as a fingerprint identifying the input block of data over which it was computed. Unlike fingerprints, however, there is a chance that two very different pieces of data will hash to the same value, resulting in a hash collision. An acceptable hash function should provide a good distribution of values over a variety of data inputs in order to prevent these collisions. Because collisions occur when different input blocks result in the same hash value, an ambiguity may arise when attempting to associate a result with a particular input.

Hash processor 210 may store a representation of each packet it observes in hash memory 220. Hash processor 210 may store the actual hash values as the packet representations or it may use other techniques for minimizing storage requirements associated with retaining hash values and other information associated therewith. A technique for minimizing storage requirements may use one or more bit arrays or Bloom filters.

Rather than storing the actual hash value, which can typically be on the order of 32 bits or more in length, hash processor 210 may use the hash value as an index for addressing a bit array within hash memory 220. In other words, when hash processor 210 generates a hash value for a block of a packet, the hash value serves as the address location into the bit array. At the address corresponding to the hash value, one or more bits may be set at the respective location thus indicating that a particular hash value, and hence a particular data packet content, has been seen by hash processor 210. For example, using a 32-bit hash value provides on the order of 4.3 billion possible index values into the bit array. Storing one bit per block rather than storing the block itself, which can be 512 bits long, produces a compression factor of 1:512. While bit arrays are described by way of example, it will be appreciated by those skilled in the relevant art, that other storage techniques may be employed without departing from the spirit of the invention.

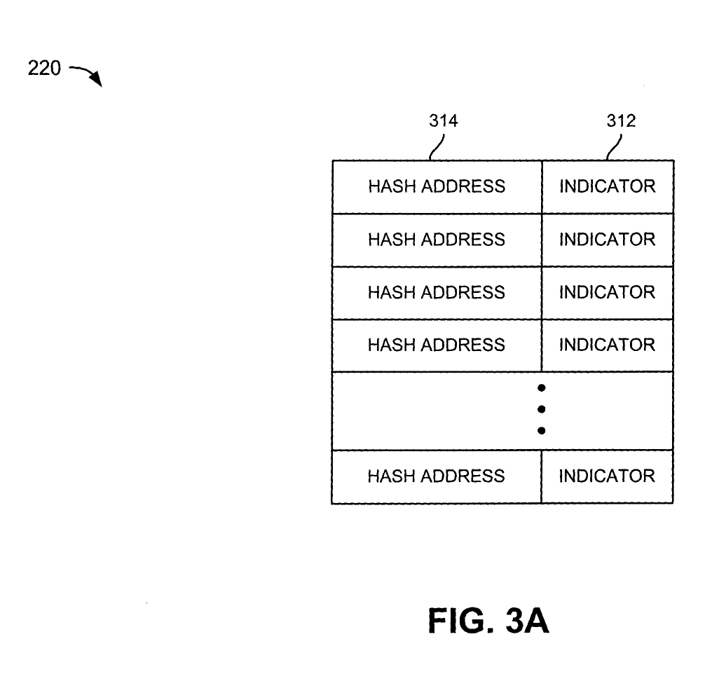

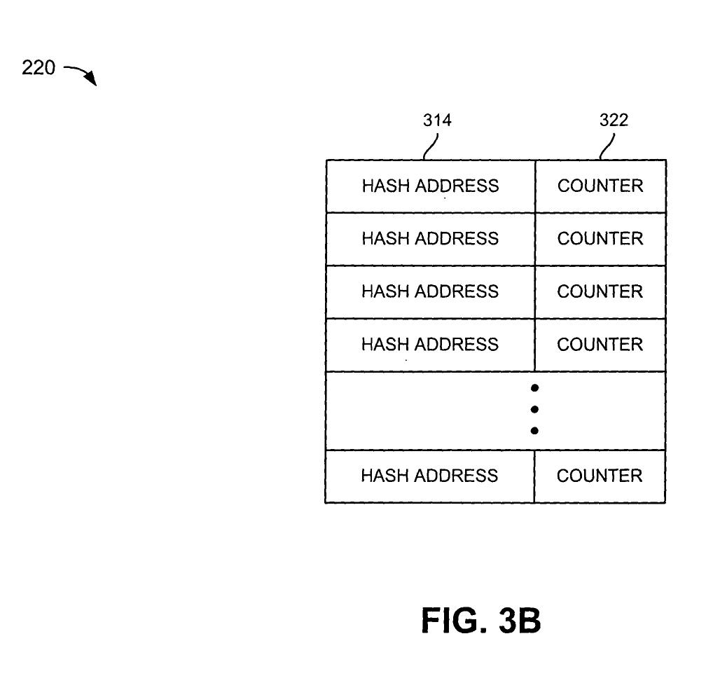

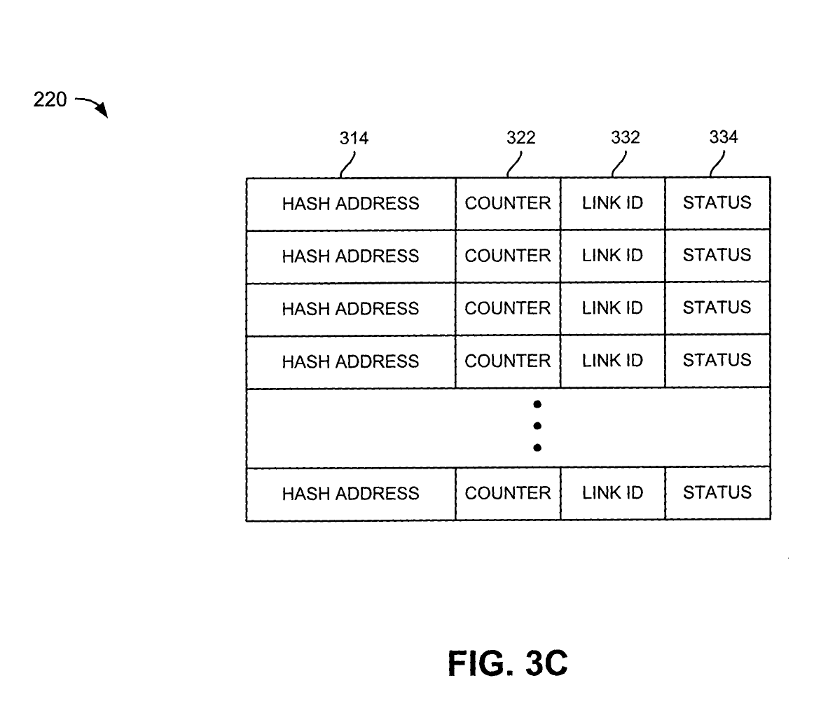

FIGS. 3A-3C illustrate three possible data structures that may be used within hash memory 220 in implementations consistent with the principles of the invention. As shown in FIG. 3A, hash memory 220 may include indicator fields 312 addressable by corresponding hash addresses 314. Hash addresses 314 may correspond to possible hash values generated by hash processor 210. Indicator field 312 may store one or more bits that indicate whether a packet block with the corresponding hash value has been observed by hash processor 210. In this case, a packet may be deemed suspicious if, during the hashing process, a significant number of the packet's hash values collide in hash memory 220. Shorter block sizes are more likely to be repeated in totally random traffic, leading to an increase in the generation of “false alarm” matches. To account for this, the threshold number of matches for “suspicion” may need to be configured somewhat higher.

As shown in FIG. 3B, hash memory 220 may alternatively include counter fields 322 addressable by corresponding hash addresses 314. Counter field 322 may record the number of occurrences of packet blocks with the corresponding hash value. Counter field 322 may be incremented on each hit. The more hits a counter receives, the more important the hit should be considered in determining the overall suspiciousness of the packet.

As shown in FIG. 3C, hash memory 220 may store additional information relating to a packet. For example, hash memory 220 may include link identifier (ID) fields 332 and status fields 334. Link ID field 332 may store information regarding the particular link upon which the packet arrived at packet detection logic 200. Status field 334 may store information to aid in monitoring the status of packet detection logic 200 or the link identified by link ID field 332.

Because shorter block sizes are more likely to be repeated in totally random traffic, another variation might include the use of different memories for different block sizes. Thus, a given count level for a shorter block size may be less reason for suspicion than the same count level found in a longer block size.

In an alternate implementation consistent with the principles of the invention, hash memory 220 may be preprogrammed to store hash values corresponding to known malicious packets, such as known viruses and worms. Hash memory 220 may store these hash values separately from the hash values of observed packets. In this case, hash processor 210 may compare a hash value for a received packet to not only the hash values of previously observed packets, but also to hash values of known malicious packets.

In yet another implementation consistent with the principles of the invention, hash memory 220 may be preprogrammed to store source addresses of known sources of legitimate duplicated content, such as packets from a multicast server, a popular page on a web server, an output from a mailing list “exploder” server, or the like. In this case, hash processor 210 may compare the source address for a received packet to the source addresses of known sources of legitimate duplicated content.

Over time, hash memory 220 may fill up and the possibility of overwriting an existing index value increases. The risk of overwriting an index value may be reduced if the bit array is periodically flushed to other storage media, such as a magnetic disk drive, optical media, solid state drive, or the like. Alternatively, the bit array may be slowly and incrementally erased. To facilitate this, a time-table may be established for flushing/erasing the bit array. If desired, the flushing/erasing cycle can be reduced by computing hash values only for a subset of the packets passing through the router. While this approach reduces the flushing/erasing cycle, it increases the possibility that a target packet may be missed (i.e., a hash value is not computed over a portion of it).

When hash memory 220 includes counter fields 322, non-zero storage locations may be decremented periodically rather than being erased. This may ensure that the “random noise” from normal packets would not remain in the bit array indefinitely. Replicated traffic (e.g., from a virus/worm propagating repeatedly across the network), however, would normally cause the relevant storage locations to stay substantially above the “background noise” level.

Exemplary Processing for Malicious Packet Detection/Prevention

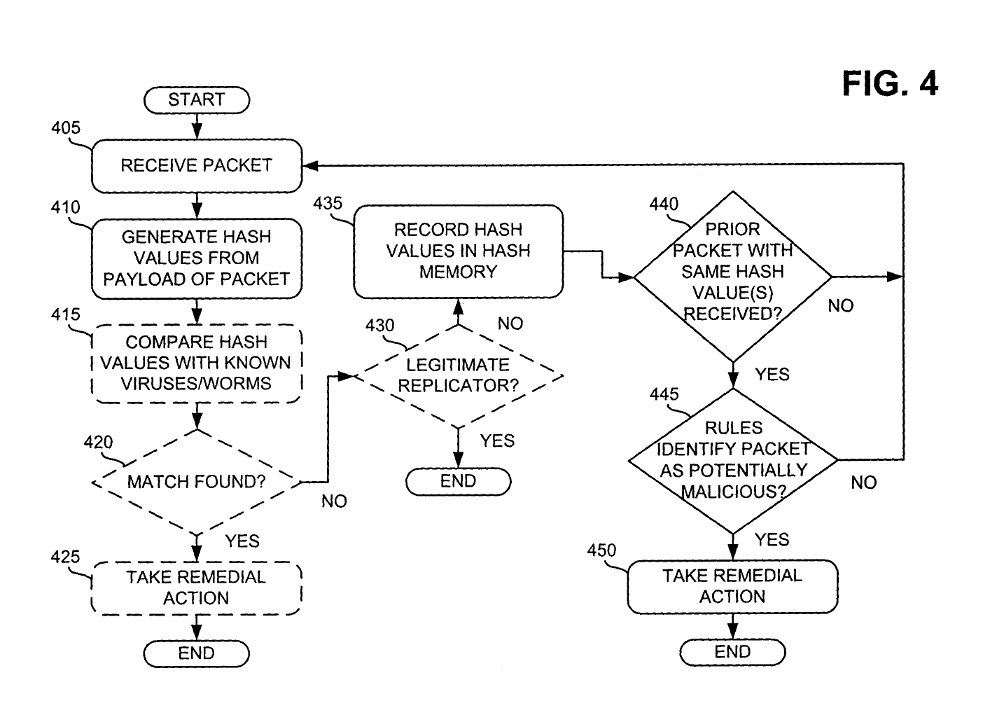

FIG. 4 is a flowchart of exemplary processing for detecting and/or preventing transmission of a malicious packet, such as a polymorphic virus or worm, according to an implementation consistent with the principles of the invention. The processing of FIG. 4 may be performed by packet detection logic 200 within a tap device, a security router, such as security router 126, an IDS, such as IDS 124, a LAN switch, or other devices configured to detect and/or prevent transmission of malicious packets. In other implementations, one or more of the described acts may be performed by other systems or devices within system 100.

Processing may begin when packet detection logic 200 receives, or otherwise observes, a packet (act 405). Hash processor 210 may generate one or more hash values by hashing variable-sized blocks from the packet's payload field (act 410). Hash processor 210 may use one or more conventional techniques to perform the hashing operation.

In one implementation consistent with the principles of the invention, three hashes may be performed covering each byte of the payload field. A hash block size may be chosen uniformly from a range of 4 to 128 bytes, in 4-byte increments. At the start of the packet payload, a random block size may be selected from this range and the block may be hashed with the three different hash functions. A new block size may then be chosen when the first block finishes, and all three hash functions may start at the same place on the new block. Alternatively, a different block size may be selected for each hash function. In this case, as each hash function completes its current block, it selects a random size for the next block it will hash.

Hash processor 210 may optionally compare the generated hash value(s) to hash values of known viruses and/or worms within hash memory 220 (act 415). In this case, hash memory 220 may be preprogrammed to store hash values corresponding to known viruses and/or worms. If one or more of the generated hash values match one of the hash values of known viruses and/or worms, hash processor 210 may take remedial actions (acts 420 and 425). The remedial actions may include raising a warning for a human operator, delaying transmission of the packet, capturing a copy of the packet for human or automated analysis, dropping the packet and possibly other packets originating from the same Internet Protocol (IP) address as the packet, sending a Transmission Control Protocol (TCP) close message to the sender thereby preventing complete transmission of the packet, disconnecting the link on which the packet was received, and/or corrupting the packet content in a way likely to render any code contained therein inert (and likely to cause the receiver to drop the packet). Some of the remedial actions, such as dropping or corrupting the packet, may be performed probabilistically based, for example, on the count value in counter field 322 (FIGS. 3B and 3C), which may also be used to determine a probability that the packet is potentially malicious.

If the generated hash value(s) do not match any of the hash values of known viruses and/or worms, or if such a comparison was not performed, hash processor 210 may optionally determine whether the packet's source address indicates that the packet was sent from a legitimate source of duplicated packet content (i.e., a legitimate “replicator”) (act 430). For example, hash processor 210 may maintain a list of legitimate replicators in hash memory 220 and check the source address of the packet with the addresses of legitimate replicators on the list. If the packet's source address matches the address of one of the legitimate replicators, then hash processor 210 may end processing of the packet. For example, processing may return to act 405 to await receipt of the next packet.

Otherwise, hash processor 210 may record the generated hash value(s) in hash memory 220 (act 435). For example, hash processor 210 may set the one or more bits stored in indicator field 312 (FIGS. 3A-3C) or increment the count value in counter field 322 (FIGS. 3B and 3C), corresponding to each of the generated hash values, to indicate that the corresponding packet was observed by hash processor 210.

Hash processor 210 may then determine whether any prior packets with the same hash value(s) have been received (act 440). For example, hash processor 210 may use each of the generated hash value(s) as an address into hash memory 220. Hash processor 210 may then examine indicator field 312 at each address to determine whether the one or more bits stored therein indicate that a prior packet has been received. Alternatively, hash processor 210 may examine counter field 322 to determine whether the count value indicates that a prior packet has been received.

If there were no prior packets received with the same hash value(s), then processing may return to act 405 to await receipt of the next packet. If hash processor 210 determines that a prior packet has been observed with the same hash value, however, hash processor 210 may determine whether the packet is potentially malicious (act 445). Hash processor 210 may use a set of rules to determine whether to identify a packet as potentially malicious. For example, the rules might specify that more than x (where x>1) packets with the same hash value have to be observed by hash processor 210 before the packets are identified as potentially malicious. The rules might also specify that these packets have to have been observed by hash processor 210 within a specified period of time of one another. The reason for the latter rule is that, in the case of malicious packets, such as polymorphic viruses and worms, multiple packets will likely pass through packet detection logic 200 within a short period of time.

A packet may contain multiple hash blocks that partially match hash blocks associated with prior packets. For example, a packet that includes multiple hash blocks may have somewhere between one and all of its hashed content blocks match hash blocks associated with prior packets. The rules might specify the number of blocks and/or the number and/or length of sequences of blocks that need to match before hash processor 210 identifies the packet as potentially malicious. The rules might differ for different block sizes.

When hash processor 210 determines that the packet is not malicious (e.g., not a polymorphic worm or virus), such as when less than x number of packets with the same hash value or less than a predetermined number of the packet blocks with the same hash values are observed or when the packets are observed outside the specified period of time, processing may return to act 405 to await receipt of the next packet. When hash processor 210 determines that the packet may be malicious, however, hash processor 210 may take remedial actions (act 450). In some cases, it may not be possible to determine whether the packet is actually malicious because there is some probability that there was a false match or a legitimate replication. As a result, hash processor 210 may determine the probability of the packet actually being malicious based on information gathered by hash processor 210.

The remedial actions may include raising a warning for a human operator, saving the packet for human analysis, dropping the packet, corrupting the packet content in a way likely to render any code contained therein inert (and likely to cause the receiver to drop the packet), delaying transmission of the packet, capturing a copy of the packet for human or automated analysis, dropping other packets originating from the same IP address as the packet, sending a TCP close message to the sender thereby preventing complete transmission of the packet, and/or disconnecting the link on which the packet was received. Some of the remedial actions, such as dropping or corrupting the packet, may be performed probabilistically based, for example, on the count value in counter field 322 (FIGS. 3B and 3C), which may also be used to determine a probability that the packet is potentially malicious. This may greatly slow the spread rate of a virus or worm without completely stopping legitimate traffic that happened to match a suspect profile.

Once a malicious packet, such as a polymorphic virus or worm, has been identified, the path taken by the malicious packet may be traced. To do this, processing similar to that described in U.S. patent application Ser. No. 10/251,403, from which this application claims priority and which has been previously incorporated by reference, may be performed.

### Conclusion

Systems and methods consistent with the present invention provide mechanisms to detect and/or prevent transmission of malicious packets, such as polymorphic viruses and worms.

Systems and methods consistent with the principles of the invention detect polymorphic viruses and worms with some finite probability, which may depend on the size of the decoder bootstrap code segment and the techniques used to obscure it (such as code rearrangement and the insertion of gibberish bytes). Also, the number of virus and worm examples that must be seen before detection becomes probable depends on the threshold settings, the degree to which different copies of the virus/worm resemble each other, the minimum hash block size used, and the rate at which copies arrive. Essentially, what happens is that short code sequences of the virus/worm decoder bootstrap will occasionally be in a single hash block, without any of the obscuring “cover” of gibberish bytes.

If the bootstrap is only obscured by inserted no-ops or irrelevant code sequences, packet detection logic 200 may eventually see samples of all variants of these in various lengths, and also in conjunction with the active code, and will actually recognize the virus/worm more easily, though usually after seeing many samples.

In either case, some set of byte sequences commonly found in the virus/worm, and found much less commonly in other network traffic, may be detected often enough that these sequences will rise above the “noise” level of the data stored in hash memory 220 and, thus, be detectable. Not every packet containing the virus/worm decoder bootstrap, however, will be detected this way, since it may be that none of the hash blocks in the particular packet isolated the fixed, active code elements. Thus, systems and methods consistent with the principles of the invention may be used to provide a warning that a virus/worm is potentially propagating and capture suspicious packets for human analysis.

Non-polymorphic viruses and worms may also be detected somewhat more quickly by these techniques because block alignment is not the same in every packet and partial matches will be more common early in the appearance of the virus/worm in the network, at least for longer packets. The certainty of detection will be correspondingly lower. So, it may take somewhat more examples of the virus/worm to reach the same degree of certainty of detection of the virus/worm, as with the fixed-length hash blocks, due to the randomness introduced into the hash-sampling process.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, systems and methods have been described with regard to network-level devices. In other implementations, the systems and methods described herein may be used with a stand-alone device at the input or output of a network link or at other protocol levels, such as in mail relay hosts (e.g., Simple Mail Transfer Protocol (SMTP) servers).

To this regard, the variable-sized block hashing technique described previously can be used in conjunction with traditional host-based virus scanning software. For example, training data may be obtained from a network application and the hash memory contents may then be transmitted to one or more hosts to aid in looking for the suspected virus or worm on the host. In other words, the host may receive hash values associated with the suspected virus or worm from the network application. The host may hash one or more variable-sized portions of the files stored in its memory to generate hash values associated with these files. The host may compare the generated hash values to the hash values associated with the suspected virus or worm and identify one or more files that may contain the suspected virus or worm when the hash values match. The technique may be used as a prioritization stage to determine which files most likely contain a virus or worm. The virus scanning software could then use other, more expensive, techniques to scan these files.

The variable-sized block hashing technique may also be used in conjunction with network-based applications, where suspicious messages are delivered to a reassembly process and the resulting messages scanned by a more conventional (e.g., execution simulating) virus detector.

While a series of acts has been described with regard to the flowchart of FIG. 4, the order of the acts may differ in other implementations consistent with the principles of the invention. In addition, non-dependent acts may be performed concurrently.

Further, certain portions of the invention have been described as “logic” that performs one or more functions. This logic may include hardware, such as an ASIC or a FPGA, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

What is claimed is:

1. A method for detecting transmission of potentially malicious packets, comprising:
receiving a plurality of packets;
generating hash values, as generated hash values, based on variable-sized blocks of the plurality of packets;
comparing the generated hash values to hash values associated with prior packets; and
determining that one of the plurality of packets is a potentially malicious packet when one or more of the generated hash values associated with the one of the plurality of packets match one or more of the hash values associated with the prior packets.

2. The method of claim 1, wherein the generating hash values includes:
hashing variable-sized blocks in a payload field of the plurality of packets to generate the hash values.

3. The method of claim 2, wherein the hashing variable-sized blocks includes:
performing a plurality of hashes covering each byte of the payload field.

4. The method of claim 2, wherein the hashing variable-sized blocks includes:
selecting a first block of a first block size, and
hashing the first block using a plurality of different hash functions.

5. The method of claim 4, wherein the hashing variable-sized blocks further includes:
selecting a second block of a second block size, and
hashing the second block using the plurality of different hash functions.

6. The method of claim 2, wherein the hashing variable-sized blocks includes:
selecting a plurality of blocks of a plurality of different block sizes, and
hashing the blocks using a plurality of different hash functions.

7. The method of claim 6, wherein the hashing variable-sized blocks further includes:
selecting a next plurality of blocks of a next plurality of different block sizes, and
hashing the next plurality of blocks using the plurality of different hash functions.

8. The method of claim 1, further comprising:
storing a plurality of hash values corresponding to known malicious packets.

9. The method of claim 8, further comprising:
comparing the generated hash values to the hash values corresponding to the known malicious packets; and
identifying one of the plurality of packets as a potentially malicious packet when one or more generated hash values corresponding to the one of the plurality of packets match one or more of the hash values corresponding to the known malicious packets.

10. The method of claim 1, further comprising:
determining whether more than a predefined number of the prior packets with the one or more of the hash values was received.

11. The method of claim 10, wherein the determining that one of the plurality of packets is a potentially malicious packet includes:
identifying the one of the plurality of packets as a potentially malicious packet when more than the predefined number of the prior packets were received within a predetermined amount of time of the one of the plurality of packets.

12. The method of claim 1, wherein the one or more generated hash values corresponding to the one of the plurality of packets include a plurality of generated hash values; and
wherein the determining that one of the plurality of packets is a potentially malicious packet includes:
identifying the one of the plurality of packets as a potentially malicious packet when at least a predetermined number of the plurality of generated hash values match the hash values associated with the prior packets.

13. The method of claim 1, wherein the potentially malicious packet is associated with one of a polymorphic virus and a polymorphic worm.

14. The method of claim 1, further comprising:
taking remedial action when the one of the plurality of packets is determined to be a potentially malicious packet.

15. The method of claim 14, wherein the taking remedial action includes at least one of:
raising a warning,
delaying transmission of the one of the plurality of packets,
capturing the one of the plurality of packets for human or automated analysis,
dropping the one of the plurality of packets,
dropping other packets originating from a same address as the one of the plurality of packets,
sending a Transmission Control Protocol (TCP) close message to a sender of the one of the plurality of packets,
disconnecting a link on which the one of the plurality of packets was received,
corrupting the one of the plurality of packets, and
probabilistically dropping or corrupting the one of the plurality of packets.

16. A system for hampering transmission of potentially malicious packets, comprising:
means for observing a plurality of packets;
means for generating hash values, as generated hash values, based on variable-sized blocks of the plurality of packets;
means for comparing the generated hash values to hash values corresponding to prior packets;
means for identifying one of the plurality of packets as a potentially malicious packet when the generated hash values corresponding to the one of the plurality of packets match the hash values corresponding to the prior packets; and
means for at least one of hampering transmission of the one of the plurality of packets and capturing a copy of the one of the plurality of packets for analysis when the one of the plurality of packets is identified as a potentially malicious packet.

17. A device for detecting transmission of malicious packets, comprising:
a hash memory configured to store information associated with a plurality of hash values corresponding to a plurality of prior packets; and
a hash processor configured to:
observe a packet,
generate one or more hash values, as one or more generated hash values, based on variable-sized blocks of the packet,
compare the one or more generated hash values to the hash values corresponding to the plurality of prior packets, and
identify the packet as a potentially malicious packet when a predetermined number of the one or more generated hash values match the hash values corresponding to the plurality of prior packets.

18. The device of claim 17, wherein when generating one or more hash values, the hash processor is configured to hash variable-sized blocks in a payload field of the packet.

19. The device of claim 18, wherein when hashing variable-sized blocks, the hash processor is configured to perform a plurality of hashes covering each byte of the payload field.

20. The device of claim 18, wherein when hashing variable-sized blocks, the hash processor is configured to:
select a first block of a first block size, and
hash the first block using a plurality of different hash functions.

21. The device of claim 20, wherein when hashing variable-sized blocks, the hash processor is further configured to:
select a second block of a second block size, and
hash the second block using the plurality of different hash functions.

22. The device of claim 18, wherein when hashing variable-sized blocks, the hash processor is configured to:
select a plurality of blocks of a plurality of different block sizes, and
hash the blocks using a plurality of different hash functions.

23. The device of claim 22, wherein when hashing variable-sized blocks, the hash processor is further configured to:
select a next plurality of blocks of a next plurality of different block sizes, and
hash the next plurality of blocks using the plurality of different hash functions.

24. The device of claim 17, wherein the hash memory is further configured to store a plurality of hash values corresponding to known malicious packets.

25. The device of claim 24, wherein the hash processor is further configured to:
compare the one or more generated hash values to the hash values corresponding to the known malicious packets, and
identify the packet as a potentially malicious packet when at least one of the one or more generated hash values matches one or more of the hash values corresponding to the known malicious packets.

26. The device of claim 17, wherein the hash processor is further configured to determine whether more than a predefined number of the plurality of prior packets with the hash values are observed by the device.

27. The device of claim 26, wherein when identifying the packet as a potentially malicious packet, the hash processor is configured to determine that the packet is a potentially malicious packet when more than the predefined number of the plurality of prior packets were observed by the device within a predetermined amount of time of observation of the packet.

28. The device of claim 17, wherein the one or more generated hash values include a plurality of generated hash values; and
wherein when identifying the packet as a potentially malicious packet, the hash processor is configured to determine that the packet is a potentially malicious packet when at least a predetermined number of the plurality of generated hash values match the hash values corresponding to the plurality of prior packets.

29. The device of claim 17, wherein the potentially malicious packet is associated with one of a polymorphic virus and a polymorphic worm.

30. The device of claim 17, wherein the hash processor is further configured to take remedial action when the packet is identified as a potentially malicious packet.

31. The device of claim 30, wherein when taking remedial action, the hash processor is configured to at least one of:
raise a warning,
delay transmission of the packet,
capture the packet for human or automated analysis,
drop the packet,
drop other packets originating from a same address as the packet,
send a Transmission Control Protocol (TCP) close message to a sender of the packet,
disconnect a link on which the packet was received,
corrupt the packet, and
probabilistically drop or corrupt the packet.

32. The device of claim 31, wherein the probabilistic dropping or corrupting of the packet is based on a probability which is related to a probability of the packet being a potentially malicious packet.

33. The device of claim 31, wherein the probabilistic dropping or corrupting of the packet is based on a probability which is unrelated to a probability of the packet being a potentially malicious packet.

34. The device of claim 17, wherein the hash processor is further configured to store information associated with the one or more generated hash values in the hash memory.

35. A method for detecting transmission of a potentially malicious packet, comprising:
receiving a packet;
selecting blocks of the received packet of random block sizes;
performing a plurality of different hash functions on each of the blocks to generate a plurality of hash values, as generated hash values;
comparing the generated hash values to hash values associated with prior packets; and
identifying the received packet as a potentially malicious packet when one or more of the generated hash values correspond to one or more of the hash values associated with the prior packets.

36. A method for detecting transmission of a potentially malicious packet, comprising:
receiving a packet;
selecting a plurality of blocks of the received packet of different block sizes;
performing a different hash function on each of the blocks to generate a plurality of hash values, as generated hash values;
comparing the generated hash values to hash values associated with prior packets; and
identifying the received packet as a potentially malicious packet when one or more of the generated hash values correspond to one or more of the hash values associated with the prior packets.

37. A method for detecting files suspected of containing a virus or worm on a computer, comprising:
receiving one or more first hash values associated with the virus or worm;
hashing one or more variable-sized portions of the files to generate second hash values;
comparing the second hash values to the one or more first hash values; and
identifying one of the files as a file suspected of containing the virus or worm when one or more of the second hash values correspond to at least one of the one or more first hash values.
